(19) United States
(12) Patent Application Publication
(10) Pub. No.: US 2021/0362414 A1
(43) Pub. Date: Nov. 25, 2021

(54) DETERMINING AN AMOUNT OF MATERIAL IN A MATERIAL SUPPLY MODULE

(71) Applicant: HEWLETT-PACKARD DEVELOPMENT COMPANY, L.P., Spring, TX (US)

(72) Inventors: Luis Vega Lastra, Sant Cugat del Valles (ES); Pau Martin Vidal, Sant Cugat del Valles (ES); Joan Mach Beneyto, Sant Cugat del Valles (ES); Gerard Mosquera Donate, Sant Cugat del Valles (ES)

(73) Assignee: HEWLETT-PACKARD DEVELOPMENT COMPANY, L.P., Spring, TX (US)

(21) Appl. No.: 17/049,250

(22) PCT Filed: Aug. 7, 2018
(86) PCT No.: PCT/US2018/045525

§ 371 Date: Oct. 20, 2020

(51) Int. Cl. B29C 64/218; B29C 64/214; B29C 64/321; B29C 64/393; B33Y 10/00; B33Y 30/00; B33Y 50/02

(52) U.S. Cl. CPC B29C 64/218; B29C 64/214; B29C 64/321; B33Y 50/02; B33Y 10/00; B33Y 30/00; B29C 64/393

(57) ABSTRACT

In one example, a rotatable delivery module is controlled to rotate in a first direction to a supply position to enable material to be supplied to an additive manufacturing platform. During such rotation to the supply position the rotatable delivery module contacts and collects respective portions of said material contained by the material supply module. An amount of material within the material supply module is determined based on a resistive force exerted on the rotatable delivery module as the rotatable delivery module collects said respective portions of material.

### BACKGROUND

Certain printing systems make use of a powdered, or powder-like, material during a printing process. For example, an additive manufacturing system, such as a three-dimensional (3D) printing system, may use a powder container to store a powdered build material. In such an arrangement, the powdered material is conveyed from the powder container to the printing system to allow printing. The powdered build material may be used to form a three-dimensional object, such as by fusing particles of build material in layers, whereby the object is generated on a layer-by-layer basis.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic perspective view of a material feeding system of a three-dimensional printing system, according to an example;

FIG. 2 is a perspective view of a material feeding system of a three-dimensional printing system, according to an example;

FIGS. 3a-3d schematically illustrate a material feeding system performing operations to determine an amount of material contained in a material supply module, according to an example;

FIG. 4 is a schematic illustration of a control circuit of a material feeding system, according to an example;

FIGS. 5A and 5B are graphical representations of the material feeding system, according to an example;

FIG. 6 is a flow chart illustrating a method, according to an example.

FIG. 7 is a flow chart illustrating a method, according to an example.

FIG. 8 is a flow chart illustrating a method, according to an example.

### DETAILED DESCRIPTION

Three-dimensional objects can be generated using additive manufacturing techniques. The objects may be generated by solidifying portions of successive layers of build material. The build material can be powder-based, and the material properties of generated objects may be dependent on the type of build material and the nature of the solidification process. In some examples, solidification of the powder material is enabled using a liquid fusing agent. In other examples, solidification may be enabled by temporary application of energy to the build material. In certain examples, fuse and/or bind agents are applied to build material, wherein a fuse agent is a material that, when a suitable amount of energy is applied to a combination of build material and fuse agent, causes the build material to melt, fuse, sinter, coalesce, or otherwise solidify. In other examples, other build materials and other methods of solidification may be used. In certain examples, the build material may be in the form of a paste or a slurry.

Examples of build materials for additive manufacturing include polymers, crystalline plastics, semi-crystalline plastics, polyethylene (PE), polylactic acid (PLA), acrylonitrile butadiene styrene (ABS), amorphous plastics, Polyvinyl Alcohol Plastic (PVA), Polyamide (e.g., nylon), thermo(setting) plastics, resins, transparent powders, colored powders, metal powder, ceramics powder such as for example glass particles, and/or a combination of at least two of these or other materials wherein such combination may include different particles each of different materials or different materials in a single compound particle. Examples of blended build materials include alumide, which may include a blend of aluminum and polyamide, and plastics/ceramics blends. There exist more build materials and blends of build materials that can be managed by an apparatus of this disclosure.

In example 3D printing systems that use powdered material, the powdered material may be conveyed from a powder storage unit to a dosing system and then to a printing platform, located next to the dosing system, and on which a printed part is built layer by layer. An example dosing system provides a dose amount of powder, which is an amount of powder sufficient to form a layer on a printing platform, for application to the printing platform. A dosing system may also be referred to as a feeding system. In example three-dimensional printing systems, powder may be applied to a printing platform using a lifting platform with a spreading mechanism that spreads material on to a printing platform from the lifting platform. The lifting platform lifts powder into the path of the spreading mechanism as the printing platform moves. An example spreading mechanism may be a roller that moves across a printing platform in a first direction to deposit a first layer of powder from a dosing system on one side of the platform and then moves in a second, opposite, direction to deposit another layer of powder from a second dosing system on the other side of the platform. In another example, powder may be applied to a printing platform using gravity.

In some three-dimensional printing systems, a dosing system may have a feeder tray to which powder is provided via an input in the feeder tray from a powder storage unit.

If the feeder tray does not contain sufficient material the likelihood of not completing a layer on the printing platform is increased, which can lead to a job failure. In addition, having varying amounts of material in the feeder tray can cause fluctuation in material densification within a layer, or from layer-to-layer, and may reduce the part quality. Furthermore, having too much material in the feeder tray can lead to wastage of excess material or a reduction in part quality due to the length of time the material has been within the dosing system.

The amount of powder in the feeder tray may be measured, for example, by compressing the powder against a flat surface. The measurement of powder through compression enables the determination of an amount of powder to be supplied so that a printing layer may be applied to the printing platform. The supply of powder to the feeder tray can then be controlled accordingly. However, measuring powder in this way can be inaccurate and may cause defects in the material, both of which may lead to reduced part quality.

Accordingly, to avoid these issues, an example method, as described herein, provides a way of accurately measuring an amount of material in a feeder tray so that a sufficient amount of material may be delivered to the feeder tray and used to form a layer on a printing platform.

An example method of determining an amount of material in a material supply module comprises controlling a rotatable delivery module to rotate in a first direction to a supply position to enable material to be supplied to an additive manufacturing platform, wherein during such rotation to the supply position the rotatable delivery module contacts and collects respective portions of said material contained by the material supply module, and determining an amount of material within the material supply module based on a resistive force exerted on the rotatable delivery module as the rotatable delivery module collects said respective portions of material.

In this way, the rotatable delivery module may complete a full or partial rotation in one direction, for example in a clockwise direction, during which material for supplying to an additive manufacturing platform will be collected; enabling an amount of material contained by a material supply module to be determined on a continuous or semi-continuous basis. Since the amount of material is determined as the delivery module rotates in a single direction to the supply position, the determination and the supply functions of the supply module are achieved during the same rotation. In this way, two partial rotations in opposite directions, a first for sensing material and a second for providing material for supply to a printing platform, are avoided. In addition, compression of the material against a surface is avoided. This means that preparation of a dose of material takes less time, which increases productivity of the dosing system and overall three-dimensional printing system. In addition, greater flexibility in print modes is achieved because a greater variety of materials may be used since the material is not rotated in a first direction (anti-clockwise) to be sensed through compression and then in a second direction (clockwise) for delivery to the supply position. For example, a material that may not perform to a satisfactory degree after being compressed against a surface can be used in the example method because its performance may not deteriorate or be affected to a significant degree when exposed to a single rotation, and without being compressed against a surface.

In addition, the capability of the rotatable delivery module to perform full rotations in a single direction increases the robustness of the sensing carried out by the module to foreign bodies within the material, for example loose screws or raised parts. In more detail, any the foreign bodies within the material would only provide a negligible resistance, if any, in addition to the resistance exerted by the material, and therefore would not significantly affect the accuracy of a determination of an amount of material. Unlike a scenario where the foreign bodies are compressed against a flat surface and possibly mistaken for an amount of powder.

In determining the amount of material based on the resistive force exerted on the rotatable delivery module during its rotation to the supply position, compression of the material against a surface or abutment is avoided thereby reducing the likelihood of artefacts developing in the material, for example, from agglomeration within the material due to increased pressure at high temperatures.

Reducing material artefacts increases the quality of the print jobs whilst reducing the likelihood of the system being forced to shut down due to artefacts disrupting the system's operation.

Moreover, determining the amount of material using the example method increases the accuracy of the material measurement, which, in turn, increases the accuracy of a subsequent determination of the amount of material to add to the material supply module. This results in less overflow material and more efficient heating of the material because less pre-heated material is wasted. Less overflow material can reduce the size of overflow tanks or eradicate the need for overflow tanks completely.

Furthermore, the rotation of the rotatable delivery module in the first direction means that the dosing system operates closer to a first in-first out material management system where a large proportion of particles of the material in a single layer have a similar age within the system, for instance, because the particles were added to the dosing system at a similar time.

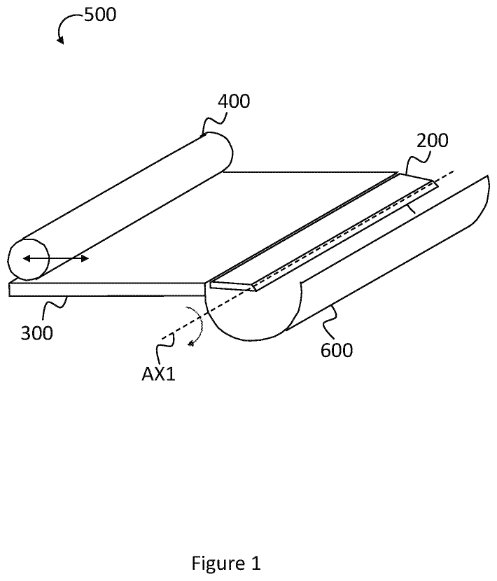

FIG. 1 shows a perspective view of an example material feeding system 500 of a 3D printing system. The material feeding system 500 has an apparatus 200 for measuring material contained by a material supply module 600, such as a feeder tray. In some examples, the material supply module 600 is thermally coupled to one or more heat elements (not shown) that adjust the material temperature.

The apparatus 200 is a rotatable delivery module that supplies or dispenses material to a building area, such as an additive manufacturing platform in the form of a three-dimensional printing platform 300, on which a part may be built by an additive manufacturing process. In the example of FIG. 1, the rotatable delivery module 200 is controllable to rotate in a clockwise direction about a longitudinal axis, AX1, depicted by the dotted line. In one example, the rotatable delivery module 200 performs a full rotation in the clockwise direction to return to its starting position. The full rotation of the rotatable delivery module 200 may be an interrupted or continuous rotation. In addition, after each full rotation, in one example, the rotatable delivery module 200 may continue to rotate and perform one or more successive full rotations, alternatively, rotation of the delivery module 200 may be paused or interrupted before a given successive rotation is performed.

The rotatable delivery module 200 is positioned within the material supply module 600, which is located adjacent the 3D printing platform 300. The material supply module 600 is a material deposit into which material is added, by a conveying mechanism through an input (not shown), and out of which material is fed or supplied to an additive manufacturing platform, such as platform 300. The feeding of the material to the platform 300 is carried out by a feeder apparatus, such as the rotatable delivery module 200, controllable by a controller (not shown).

The input to the material supply module 600 is located on a bottom surface of the material supply module 600 and may be positioned in the center of the bottom surface.

The material supply module 600 has a semi-circular cross section in the plane perpendicular to the length of the material supply module 600. Within the same plane, the rotatable delivery module 200 has a cross-sectional width that allows the rotatable delivery module 200 to rotate within the material supply module 600, whilst avoiding build-up of stagnant material in cavities or hotspots, reducing artefacts in the material. The semi-circular cross section of the module 600 also means that the likelihood of foreign bodies, such as loose screws, becoming stuck within the module 600 is reduced.

A dose amount of the material is provided from the material supply module 600 by the rotatable delivery module 200 so that a layer of material can be formed on the printing platform 300. In one example, a dose amount of material may be one of the following: 6 grams, 8 grams, 10 grams, 12 grams, 14 grams, and 16 grams. The dose amount of material is an amount that is at least enough to form a layer of material on the platform 300 and may be a predetermined amount of material.

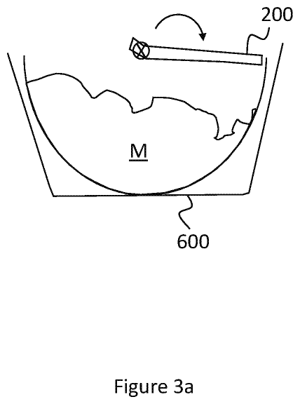

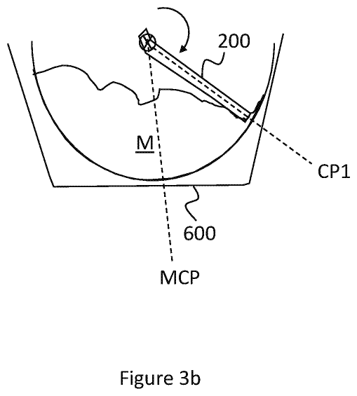

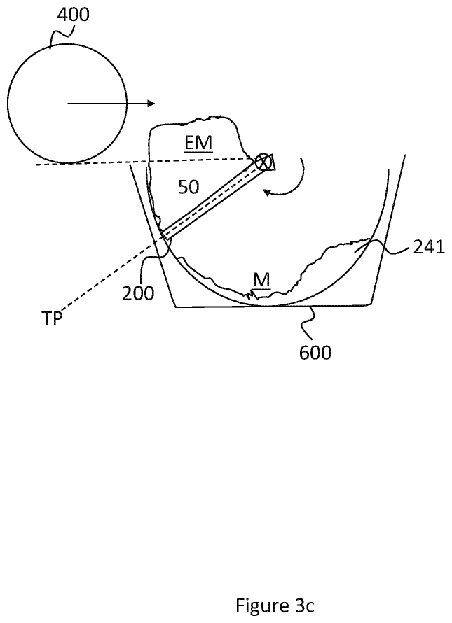

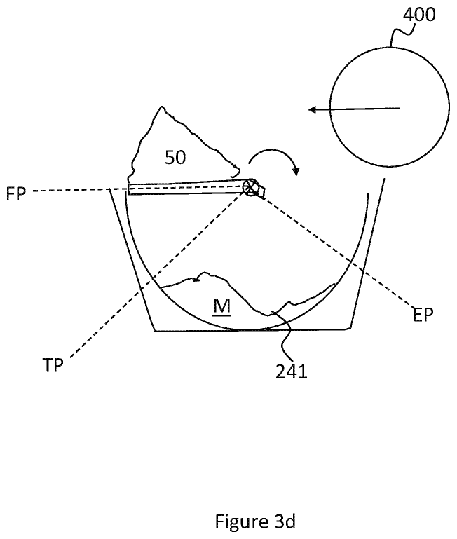

As each dose is applied to the printing platform 300, the material supply module 600 receives additional material through the input so that the material level within the module 600 is maintained at a steady state. In another example, the material within the module 600 may be maintained within one or more predetermined levels. The amount of additional material supplied to the material supply module 600 is based on how much material the material supply module 600 contains, which can be determined using the rotatable delivery module 200, as described in more detail in relation to FIG. 3.

Referring again to FIG. 1, the material feeding system 500 has an element 400 that transfers the dose amount of material from the rotatable delivery module 200 to the printing platform 300. The element 400 is depicted as cylindrical roller but in an alternative example may be a blade or a sliding carriage holding an appropriate transferring element.

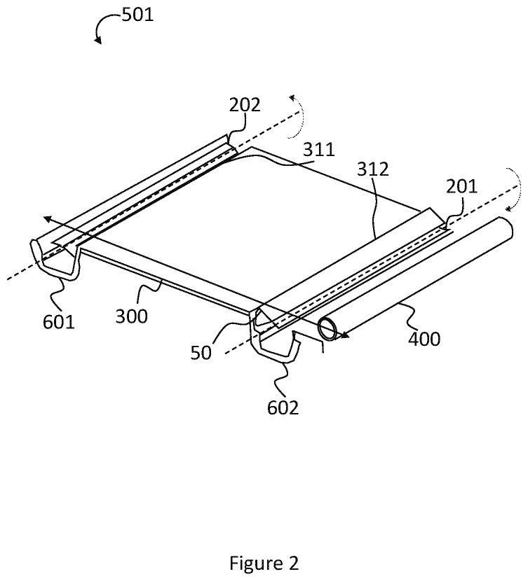

FIG. 2 shows another example of a material feeding system 501 of a 3D printing system. The system 501 is the same as the system 500 of FIG. 1 but has a first material supply module 601 adjacent a first edge 311 of the printing platform 300 and a second material supply module 602 positioned along a second edge 312 of the printing platform 300, where the first edge 311 is opposite the second edge. The element 400 transfers a dose amount of material, for example, dose 50, to the platform 300 each time it moves from behind one of the material supply modules, across the platform 300, to a position behind the other material supply module.

For system 501, the time to supply a dose amount of material corresponds to the time taken for the element 400 to apply two layers of material to the printing platform 300.

FIGS. 3a-3d depict the rotatable delivery module 200 at sequential stages of a material supply process.

FIG. 3a shows the rotatable delivery module 200 in a starting position, where the rotatable delivery module 200 is not in contact with the material M, held within the material supply module 600. As described with reference to FIG. 1, the rotatable delivery module 200 is controllable to rotate in a clockwise direction such that the delivery module 200 contacts and collects respective portions of material contained by the material supply module 600 as it rotates.

The rotatable delivery module 200 is a planar structure with a longitudinal axis (not shown in this Figure) arranged such that the longitudinal axis is parallel to the edge of the printing platform 300; as such the rotatable delivery module 200 may be referred to as a vane. In another example, the rotatable delivery module 200 may have a plurality of distribution features that distribute material within the material supply module 600 as the rotatable delivery module 200 rotates.

FIG. 3b shows the rotatable delivery module 200 in an initial contact position, CP1, where the rotatable delivery module 200 makes first contact with the material M after the rotatable delivery module 200 has rotated in a clockwise direction from the starting position of FIG. 3a.

As the rotatable delivery module 200 rotates past the initial contact position, CP1, of FIG. 3b, to sweep through the material M, a resistive force is exerted on the rotatable delivery module 200 as the rotatable delivery module 200 collects the respective portions of material. The resistive force may also be referred to as resistive torque.

The amount of material held by the material supply module 600 is determined based on the resistive force experienced by the rotatable delivery module 200 using a general principle that the greater the amount of material within the material supply module, 600, the greater the resistive force exerted on the rotatable delivery module as it contacts and collects respective portions of material. The rotatable delivery module 200 experiences the largest force at the position at which the module 200 rotates against the largest proportion of material within the material supply module 600, which is effectively the position of the module 200 at which the largest proportion of material in the supply module 600 is displaced, herein referred to as the major contact position, MCP. The location of the major contact position within the module 600 may vary depending on the amount of material in the supply module 600. In other examples, the arrangement of the material within the material supply module 600 may affect the position at which the module 200 experiences the largest resistive force form the material.

FIG. 3c shows the rotatable delivery module 200 in a trimming position, TP, after the rotatable delivery module 200 has rotated in a clockwise direction from the contact position, CP1, of FIG. 3b, through the major contact position, MCP. In the trimming position, TP, the element 400 trims excess material, EM, from the material collected by the rotatable delivery module 200 by moving across the material supply module 600, leaving a dose amount of material 50 on the rotatable delivery module 200.

FIG. 3d shows the rotatable delivery module in a supply or feed position, FP, in which the rotatable delivery module 200 is substantially in alignment with the printing platform 300 of FIGS. 1 and 2 and holds a dose 50 of material for supply thereto. Rotation of the rotatable delivery module 200 is paused at the feed position, FP, to allow the element 400 to move the dose amount 50 from the module 200 to a build area of the printing platform 300.

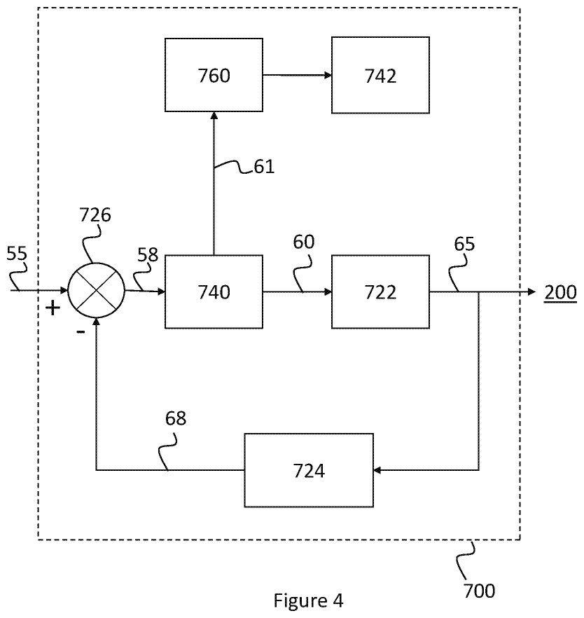

FIG. 4 is a schematic illustration of a control circuit 700 of the rotatable delivery module 200.

The control circuit 700 controls the rotation of the rotatable delivery module 200.

The control circuit 700 has a controller 740, a motor 722, a memory 760, an error detector 726, a first processor 724, and a second processor 742.

The controller 740 outputs a drive signal 60 that is input to the motor 722. Based on the drive signal 60, the motor 722 outputs a signal 65 that controls the movement of the rotatable delivery module 200. The signal 65 is sampled by the first processor 724.

As an example, the motor 722 may be an electromechanical motor and the first processor 724 may be a motor encoder, and together the motor 722 and the first processor 724 may form a servo-controller.

The processor 724 monitors the signal 65, and hence, the motion of the motor 722, as a proxy to the motion of the rotatable delivery module 200. As an example, the processor 724 monitors the angular position and/or speed of the rotatable delivery module 200 over time based on the angular position and/or speed of the motor 722, which can be determined from the signal 65.

The processor 724 determines an angular position and/or speed of the delivery module 200 at a particular moment in time and outputs a signal 68 representative of the determined angular position and/or speed to the error detector 726.

The error detector 726 receives a signal 55 representative of a target angular position and/or speed for the rotatable delivery module 200 and determines an error based on a comparison between the signal 55 and the signal 68, or data representative thereof. The error detector 726 transits a signal 58 representative of the error to the controller 740. The controller 740 then adjusts the drive signal 60 based on the error signal 58. In this way, the controller 740, the processor 724 and the motor 722 are a close-loop control system.

The controller 740 provides a secondary signal 61 to the memory 760. The signal 61 is representative of the drive signal 60 to enable the second processor 742, coupled to the memory 760, to determine the amount of material within the material supply module 600. In one example, the second processor 742 may communicate with a controller of a conveying system (not shown) so that the conveying system controller may initiate conveying of an amount of material from a powder storage unit to the material supply module 600, based on the determined amount of material within the module 600.

In a variation to the control system 700 of FIG. 4, the controller 740 may determine the amount of material in the supply module 600.

In another variation to the control system 700 of FIG. 4, the error detector 726 may be incorporated into the controller 740, whereby the controller 740 may be a PID unit that receives the signal 68 from the encoder 724 and the signal 55. In another example, the values of the target angular position and/or speed may be retrieved from the memory 760.

Before rotation of the rotatable delivery module 200 begins, a reference speed of rotation of the rotatable delivery module 200 is set based on a desired destination of the rotatable delivery module 200, for example, the supply position. In one example, the signal 55 may be representative, at least initially, of the reference speed of rotation. The rotatable delivery module 200 is driven by means of the motor 722 to rotate to the supply position, at the reference speed. In so doing, as the rotatable delivery module 200 contacts and collects respective portions of material within the material supply module 600 a resistive force is exerted on the rotatable delivery module 200.

The resistive force causes a change in the rotational speed of the rotatable delivery module 200 and, as described above, the processor 724 outputs the signal 68 representative of the rotational speed or position of the module 200, which in turn changes the error signal 58, whereby the controller 740 then adjusts the drive signal 60 to overcome at least a portion of the resistive force and thereby mitigate the change in rotational speed of the delivery module 200.

In one example, the processor 724 monitors the rotation of the rotatable delivery module 200 in accordance with a sampling rate. As an example, the processor 724 may sample the signal 65 every 5 ms, every 10 ms, every 20 ms. In an example where the processor 724 and the motor 722 form a servo-controller, the motion of the rotatable delivery module 200 may be interrupted in accordance with an interruption rate of 5 ms, 10 ms, or 20 ms, where an interruption may last up to 10 ms.

The drive signal 60 may be a pulse width modulation signal, PWM, signal and, in such a case, the processor 724 adjusts the duty cycle thereof to adjust the drive signal 60.

The processor 740 determines an amount of material in the material supply module 600 based on the adjusted signal 60. For example, a threshold value may be used by the processor 740 to determine the amount of material in the material supply module 600. This may be referred to as a threshold or bump mode and involves a comparison between a value of the adjusted signal and a threshold value. The threshold value is set to increase the likelihood of accurately determining the amount of material in the material supply module whilst reducing the likelihood of falsely determining an amount of material based on a signal adjusted to overcome inefficiencies, for example, in the motor, rather than a force exerted by material in the supply module. Accordingly, if the value of the adjusted signal is greater than or equal to the threshold value, the processor 740 determines the amount of material based on an angular position, α_{TH}, of the module 200 at the point in time that the value of the adjusted signal is determined to be greater than or equal to the threshold value.

In one example, an angular representation of the amount of material is used to determine the amount of material in the material supply module 600. The angular representation of the amount of material is determined using the following formula:

α_{powder}=α_{SP}−α_{Th}

where, α_{powder} is the angular representation of the amount of material within the material supply module (explained in more detail below), α_{SP} is the angular position of a fixed point in the rotatable delivery module, for example, a fixed point corresponding to the lowest point in the module or a fixed point corresponding to the supply position, and α_{TH} is the angular position at which the value of the adjusted signal is greater than or equal to the threshold value. In other words, the angular representation of the amount of material corresponds to an angular displacement spanning between the supply position and the angular position of the rotatable delivery module at the point in time at which the adjusted drive signal is determined to be greater than or equal to the threshold value.

The angle of material α_{powder} is related to the amount of material, Aₘ, according to the following formula:

Aₘ=Z×α_{powder}.

where Z is a coefficient and may depend on the type of material, for example, the cohesiveness and density of the material, and/or the unit of measurement, for example, grams or kilograms per degree. In one example, the angle of material may be linearly related to the amount of material.

If the drive signal 60 is a PWM signal, the threshold value corresponds to a threshold duty cycle, for example, one of the following: 5%, 10%, 15%, or 20%. In some examples, the threshold value corresponds to the lowest possible threshold duty cycle at which amounts of material exert force on the module 200 and can thereby be detected by the example method. In one example, if a total available voltage is 24V, a threshold duty cycle of 10% results in a PWM voltage of 2.4V.

A minimum value for the duty cycle of the drive signal 60 is used to rotate the rotatable delivery module 200 without any material contact or collection, as such, the minimum value for the duty cycle limits the minimum value of the threshold duty cycle. The minimum value may depend on one or more of the geometry, size and weight of the delivery module 200. As an example, a minimum value for the duty cycle may be 3%. In this case, the threshold value may be 6% to give an approximate 2% error window or variability.

In addition, a maximum duty cycle value may limit the threshold duty cycle value. For instance, the maximum duty cycle value may represent a duty cycle value above which the accuracy of the determination of the amount of material decreases. As an example, a maximum duty cycle may be 15%.

The threshold value may depend upon efficiency of driving of the rotatable delivery module 200 by the motor 722 and material type, for example, a material with a lower level of cohesiveness will not warrant as much of an increase in the PWM signal as a material with a higher level of cohesiveness.

In a further example, the control circuit 700 may operate in a second mode, whereby the processor 724 operates in a similar way as in the first mode, but the processor 740 uses an average value of the adjusted drive signal 60 to determine the amount of material in the material supply module 600 instead of a threshold value. The second mode may be referred to as an averaging or PWM average mode.

In more detail, the processor 740 determines an average value of the adjusted drive signal 60 within an averaging window and subsequently determines the amount of material, Aₘ, based on the average value, Av_{PWM}, using the following formula:

Aₘ=Q×Aν_{PWM}.

where Q is a coefficient and may vary dependent on the type of material, for example, the cohesiveness and density of the material, and/or the unit of measurement, for example, grams or kilograms. In one example, Q may define a linear relationship between the amount of material and the average value.

The averaging window may be defined temporally or spatially. In one case, the averaging window is defined by a first angular position and a second angular position that are set such that the averaging window includes the angular position at which the rotatable delivery module 200 is estimated to experience a largest exertion of resistive force, such as the angular position at which the module 200 contacts a first portion of the respective portions of material, depicted by contact position CP1 of FIG. 3b. In this way, the determination by the processor 740 using the averaging window encompasses the adjusted drive signal 60 input to the motor to overcome the force exerted on the delivery module 200 at contact position, CP1, and, thus, will result in an accurate determination of the amount of material in the material supply module 600.

In one example, processor 740 communicates the determined amount of material to a conveying system that inputs material to the material supply module 600 from a material storage unit, to control the amount of material that is input to the material supply module 600.

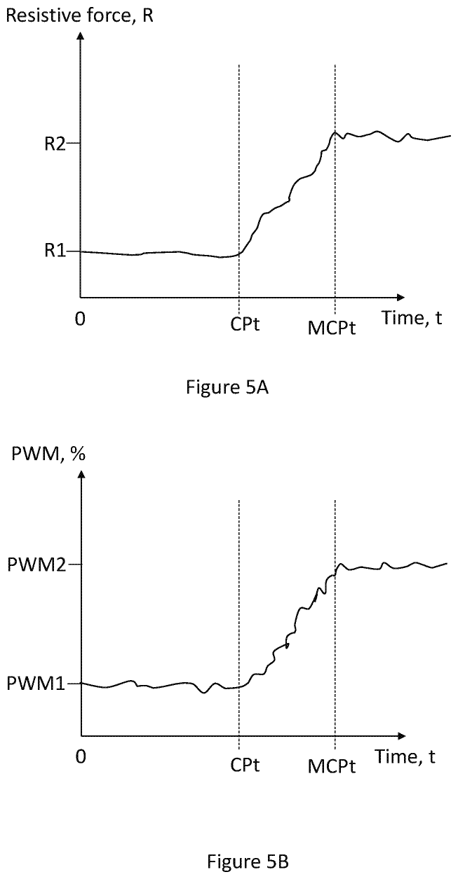

FIGS. 5A and 5B are example graphical representations of the variation in resistive force and PWM value as the rotatable delivery module 200 rotates.

FIG. 5A depicts an increase from a first resistive force, R1, to a second resistive force, R2, where the increase occurs after the time, CPt, at which the rotatable delivery module 200 initially contacts the material in the material supply module at contact position CP1 of FIG. 3b. The increase in resistive force is depicted as a ramp that reaches its highest point at a time corresponding to, or close after, the time, MCPt, at which the rotatable delivery module 200 experiences the largest resistive force from the material. The first resistive force R1 represents the resistive force exerted on the module 200 as it rotates, but before the module 200 contacts material within the supply module 600. For example, the resistive force R1 may correspond to one or more of air resistance and friction between the rotating module 200 and any non-moving components that are coupled to the module 200.

FIG. 5B depicts an increase from a first PWM value, PWM1, to a second PWM value PWM2, at a time offset from the time, CPt, at which the rotatable delivery module 200 contacts the material in the material supply module at contact position CP1 of FIG. 3b. Accordingly, FIG. 5B illustrates the reactive adjustment of the signal input to the rotatable delivery module 200 due to the increase in resistive force shown in FIG. 5A. In this example, the rotatable delivery module rotates at a constant speed and so the increase in the PWM value follows a similar upward ramp to the increase in resistive force, depicted in FIG. 5A. The value PWM1 corresponds to the minimum PWM that causes the rotatable delivery module 200 to rotate, in other words, PWM1 is the minimum PWM that overcomes the resistive force R1.

In another example, the rotatable delivery module 200 may be driven to rotate at a variable speed. In such a scenario, the PWM value would be set to correspond to the variable speed and overcome the resistive force. For instance, if the speed of rotation of the module is set to increase, the PWM value would increase to meet the increased speed and to overcome the resistive force of the material.

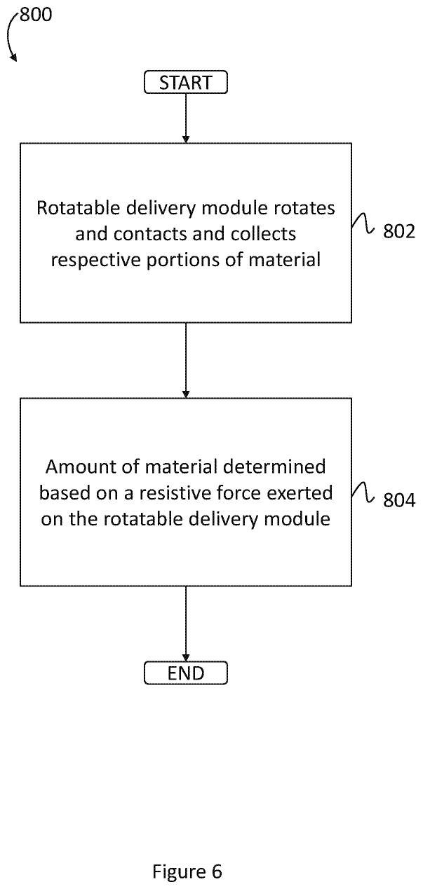

FIG. 6 is a flowchart illustrating an example method 800 of determining an amount of material in a material supply module 600 using the rotatable delivery module 200 described in relation to FIGS. 1-5b.

At block 802, the rotatable delivery module is controlled to rotate in a first direction to a supply position. During the rotation the rotatable delivery module contacts and collects respective portions of material contained by the material supply module.

At block 804, an amount of material contained by the material supply module is determined based on a resistive force exerted on the rotatable delivery module as it collects respective portions of the material.

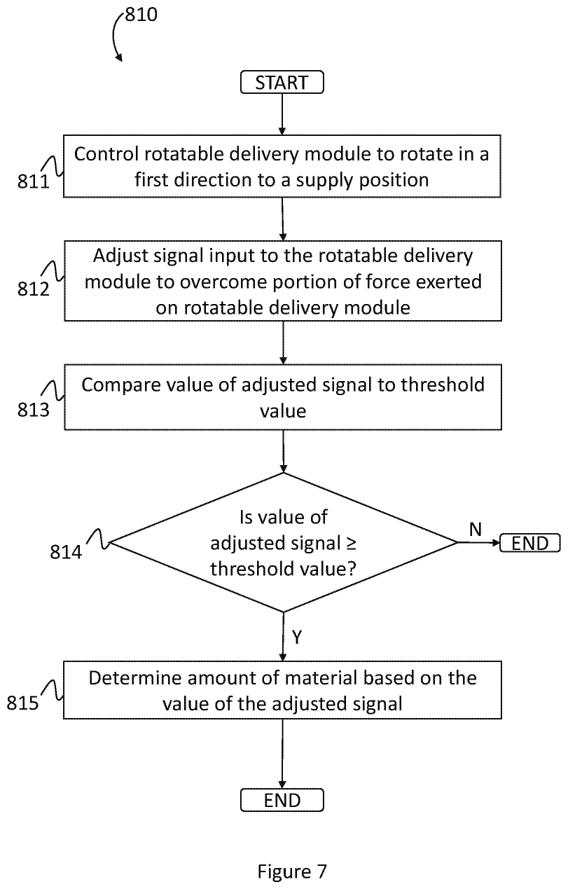

FIG. 7 is a flowchart illustrating an example method 810 of determining an amount of material in a material supply module using the rotatable delivery module 200 described in relation to FIGS. 1-5b. Method 810 is an example implementation of method 800.

At block 811, the rotatable delivery module is controlled to rotate in a first direction to a supply position. During the rotation the rotatable delivery module contacts and collects respective portions of material contained by the material supply module.

At block 812, an adjustment is made to the signal input to the rotatable delivery module to overcome at least a portion of the force exerted on the rotatable delivery module as it contacts and collects respective portions of the material. Next, at block 813, a comparison is made between a value of the adjusted signal and a threshold value. At block 814, a determination as to whether the value of the adjusted signal is greater than or equal to the threshold value. If yes, Y, the method 810 proceeds to block 815. If no, N, the method ends to avoid an endless loop in a scenario where the amount of material is zero or under a minimum amount that is capable of being sensed. In one example, the “N” branch may result in the amount of material being assumed to be zero.

At block 815, the amount of material in the material supply module is determined based on the value of the adjusted signal.

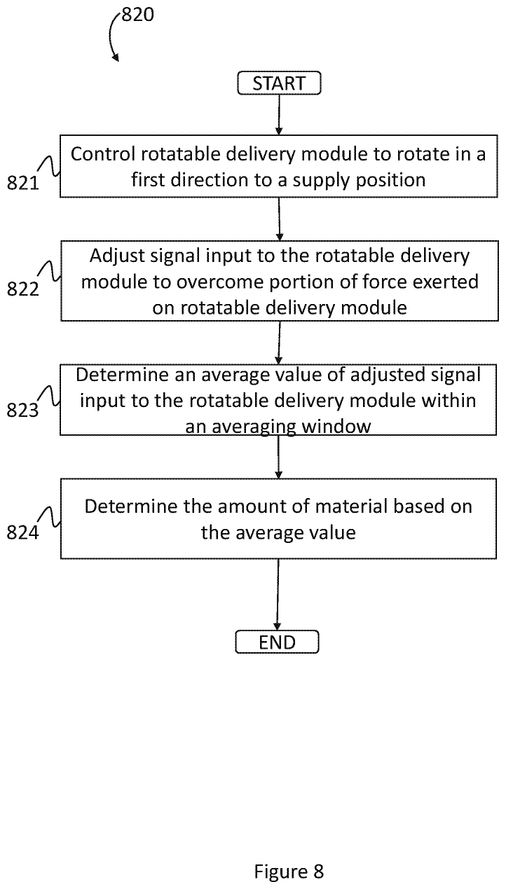

FIG. 8 is a flowchart illustrating an example method 820 of determining an amount of material in a material supply module using the rotatable delivery module 200 described in relation to FIGS. 1-5b. Method 820 is an example implementation of method 800.

At block 821, the rotatable delivery module is controlled to rotate in a first direction to a supply position. During the rotation the rotatable delivery module contacts and collects respective portions of material contained by the material supply module.

At block 822, an adjustment is made to the signal input to the rotatable delivery module to overcome at least a portion of the force exerted on the rotatable delivery module as it contacts and collects respective portions of the material. Next, at block 823, an average value of the adjusted signal within an averaging window is determined.

At block 824, the amount of material in the material supply module is determined based on the average value.

In the preceding description a processor or controller component may act as a central processing unit and be configured to execute a program, such as a computer program or software application stored in memory, to interpret the data contained within or represented by any received signals.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
controlling a rotatable delivery module to rotate in a first direction to a supply position to enable material to be supplied to an additive manufacturing platform, wherein during such rotation to the supply position the rotatable delivery module contacts and collects respective portions of said material contained by the material supply module, and
determining an amount of material within the material supply module based on a resistive force exerted on the rotatable delivery module as the rotatable delivery module collects the respective portions of material.

2. The method of claim 1, wherein said rotation of the rotatable delivery module in the first direction is controlled via a signal that is input to the rotatable delivery module, and said determining the amount of material within the material supply module based on the resistive force comprises:
adjusting the signal input to the rotatable delivery module to overcome at least a portion of the resistive force; and
determining the amount of material based on the adjusted signal.

3. The method of claim 2, comprising:
comparing a value of the adjusted signal to a threshold value, wherein if the value of the adjusted signal is greater than or equal to the threshold value, determining the amount of material based on the value of the adjusted signal.

4. The method of claim 2, comprising:
determining an average value of the adjusted signal within an averaging window; and
determining the amount of material based on the average value.

5. The method of claim 4, wherein the averaging window is defined by first and second angular positions.

6. The method of claim 5, wherein during the rotation of the rotatable delivery module to the supply position, the rotatable delivery module rotates to a third angular position at which the rotatable delivery module contacts a first portion of the respective portions of material, whereby the third angular position is located between the first angular position and the second angular position.

7. The method of claim 2, wherein the signal is a pulse width modulation, PWM, signal and adjusting the signal comprises modifying the duty cycle of the PWM signal.

8. The method of claim 2, wherein the rotatable delivery supply module comprises a vane arranged to collect and contact the respective portions of the material during the rotation of the rotatable delivery module in the first direction; wherein adjusting the signal input to the rotatable delivery module comprises:
determining an angular position of the vane;
comparing the angular position of the vane to a predetermined angular position;
determining a position error based on the comparing, wherein the position error is representative of the resistive force exerted by the portion of material on the rotatable delivery module; and
adjusting the signal input to the rotatable delivery module based on the position error.

9. The method of claim 1, comprising:
determining an amount of material to be input to the material supply module based on the determined amount of material within the material supply module.

10. The method of claim 1, comprising:
controlling the rotatable delivery module to perform a full rotation in the first direction.

11. A material calculation system comprising:
a rotatable dispenser module; and
a computer processor;
wherein:
the rotatable dispenser module is controllable to rotate in a first direction to a feed position to enable material to be applied to an additive manufacturing platform,
the rotatable dispenser module is arranged relative to a material supply module to contain said material such that the rotatable dispenser module contacts and collects respective portions of said material contained by the material supply module during said rotation to the feed position; and
the computer processor is configured to identify an amount of material contained by the material supply module based on a resistive force exerted on the rotatable delivery module as the rotatable delivery module collects said respective portions of material.

12. The material calculation system of claim 11, wherein:
the rotatable delivery module is controllable via a signal that is supplied to the rotatable delivery module;
the signal is adjusted to overcome at least a portion of the resistive force; and
the computer processor is configured to identify the amount of material contained by the material supply module based on the adjusted signal.

13. The material calculation system of claim 12, wherein the computer processor is configured to:
compare a value of the adjusted signal to a predetermined value; and if the value of the adjusted signal is greater than or equal to the predetermined value, identify the amount of material based on the value of the adjusted signal.

14. The material calculation system of claim 12, wherein the computer processor is configured to:
determine an average value of the adjusted signal within an averaging window; and
identify the amount of material based on the average value.

15. A computer readable medium comprising instructions that when executed by a processor, cause the processor to:
instruct a rotatable delivery module to rotate in a first direction to a supply position to enable material to be supplied to an additive manufacturing platform, wherein during such rotation to the supply position the rotatable delivery module contacts and collects respective portions of said material contained by a material supply module, and
determine an amount of material within the material supply module based on a resistive force exerted on the rotatable delivery module as the rotatable delivery module collects said respective portions of material.
